(19) United States
(12) Patent Application Publication
(10) Pub. No.: US 2024/0356109 A1
(43) Pub. Date: Oct. 24, 2024

(54) BATTERY MODULE AND A BATTERY PACK CONTAINING THE BATTERY MODULES

(71) Applicant: Clean Electric Private Limited, Bhopal (IN)

(72) Inventors: Abhinav ROY, Begusarai (IN); Ankit JOSHI, Nimbahera, Chittorgarh (IN); Akash GUPTA, Bhopal (IN); Praveen Kumar YADAV, Ghazipur (IN)

(21) Appl. No.: 18/686,837

(22) PCT Filed: Aug. 26, 2022
(86) PCT No.: PCT/IN2022/050759

§ 371 Date: Feb. 26, 2024

(30) Foreign Application Priority Data
Aug. 26, 2021 (IN) 202121038680

(51) Int. Cl. H01M 10/6568; H01M 10/613; H01M 50/213; H01M 50/291; H01M 50/293; H01M 50/505

(52) U.S. Cl. CPC H01M 10/6568; H01M 10/613; H01M 50/213; H01M 50/291; H01M 50/293; H01M 50/505

(57) ABSTRACT

A battery module (102) is contained in a battery pack (100) and includes plural cells (118), a first cell holder (112), a second cell holder (114), and a current collector (116). The first cell holder (112) and the second cell holder (114) each have plural pockets to retain the cells (118). The first cell holder (112) and the second cell holder (114) are assembled to form a manifold to partially submerge the cells (118) within fluid. In addition, an interface (130) between a curved surface of the cells (118) and a curved surface of the pockets of at least one of the first cell holder (112) and the second cell holder (114) is sealed using a sealant. Further, the interface between the first cell holder (112) and the second cell holder (114) is sealed.

### FIELD OF THE INVENTION

The embodiments of the present invention generally relate to batteries, and more particularly, the embodiments of the present invention relate to a battery module, and a battery pack containing the battery modules.

### BACKGROUND

Batteries are an important source of electric power. The batteries are used in various applications such as electric vehicle energy storage, power plant energy storage, wind energy storage, solar energy storage etc. The batteries can usually be charged, discharged into a load, and recharged many times. Due to the charging and discharging of a battery, cells of such batteries generate significant amount of heat.

When the significant amount of heat is generated, undesirable effects can impact the operation of the batteries. Such batteries are less safe in case of a thermal runaway event. Thus, the batteries are provided with cooling system to combat heat generation events. The cooling systems ordinarily provide indirect cooling of the cells through cooling channels and have a small thermal contact area with the cells. Since the temperature difference within such cells is huge, such cooling systems are inefficient and restrict the charging of the batteries at high C rates. Also, using the conventional cooling system increases the dead weight of the batteries.

In view of the above, there remains a need for a novel and an inventive battery pack that can overcome the above-mentioned limitations.

### OBJECT OF THE INVENTION

An object of the present invention is to provide a battery module.

Another object of the present invention is to provide a battery pack containing the battery modules.

Another object of the present invention is to provide a battery module and a battery pack that allows better heat transfer.

Another object of the present invention is to provide a battery module and a battery pack to increase overall energy density.

Another object of the present invention is to provide a battery module and a battery pack having better structural stiffness.

Another object of the present invention is to provide a battery module and a battery pack that eliminates the dead weight.

### SUMMARY OF THE INVENTION

According to an aspect of the present invention, a battery module is disclosed. The battery module includes a plurality of cells, a first cell holder, and a second cell holder. The first cell holder and the second cell holder each have a plurality of pockets to retain the plurality of cells inside the battery module. In addition, the first cell holder and the second cell holder are operably assembled to form a manifold for partial submersion of the plurality of cells within a coolant fluid and for the flow of the coolant fluid. Additionally, an interface between curved surface of the plurality of cells and curved surface on the plurality of pockets of at least one of the first cell holder and the second cell holder is sealed using a sealant. Further, an interface between the first cell holder and the second cell holder is sealed. The battery module further includes a current collector. The current collector is electrically coupled to the plurality of cells. The current collector has a first module terminal and a second module terminal. Moreover, one of the first module terminal and the second module terminal extends throughout a length of the plurality of cells.

In accordance with an embodiment of the present invention, the flow of the coolant fluid in the battery module may be reversed at predefined intervals during high charging and discharging rates to ensure homogeneous cell surface temperature.

In accordance with an embodiment of the present invention, the coolant fluid may be one of a hydrocarbon-based dielectric oil and a deionized water.

In accordance with an embodiment of the present invention, the coolant fluid may be in contact with at least 70 percent of a curved surface area of the plurality of cells.

In accordance with an embodiment of the present invention, the first cell holder and the second cell holder each may have at least one coolant port for allowing the flow of the coolant fluid into the battery module and out of the battery module. The coolant port may be one of a female coolant port and a male coolant port. The male coolant port of the battery module may be arranged to be received in the female coolant port of the adjacent battery module.

In accordance with an embodiment of the present invention, the interface between the first cell holder and the second cell holder may be sealed using at least one of a mechanical gasket and at least one projection and recess filled with the sealant.

In accordance with an embodiment of the present invention, one of the first cell holder and the second cell holder may have a plurality of pins to locate the current collector. The plurality of pins may be plastically deformed to hold the current collector in place adjacent to one of the first cell holder and the second cell holder.

In accordance with an embodiment of the present invention, the first cell holder and the second cell holder may be made of material selected from a group consisting of Nylon, High Crystalline Polypropylene, and Polypropylene Copolymer.

In accordance with an embodiment of the present invention, the flow of the coolant fluid may be a cross flow which ensures efficient cooling of the plurality of cells.

According to another aspect of the present invention, a battery pack is disclosed. The battery pack includes at least one battery module. The battery module includes a plurality of cells, a first cell holder, and a second cell holder. The first cell holder and the second cell holder each have a plurality of pockets to retain the plurality of cells inside the battery module. In addition, the first cell holder and the second cell holder are operably assembled to form the manifold for partial submersion of the plurality of cells within a coolant fluid and for the flow of the coolant fluid. Additionally, the interface between curved surface of the plurality of cells and curved surface on the plurality of pockets of at least one of the first cell holder and the second cell holder is sealed using the sealant. Further, the interface between the first cell holder and the second cell holder is sealed. The battery module further includes a current collector. The current collector is electrically coupled to the plurality of cells. The current collector has a first module terminal and a second module terminal. The first module terminal and the second module terminal of the battery module are electrically connected to adjacent battery module to form the battery pack. Moreover, one of the first module terminal and the second module terminal extends throughout the length of the plurality of cells.

In accordance with an embodiment of the present invention, the first cell holder and the second cell holder each may have at least one coolant port to allow the flow of the coolant fluid into the battery module and out of the battery module. The coolant port may be one of the female coolant port and the male coolant port. The male coolant port of the battery module may be arranged to be received in the female coolant port of adjacent battery module while forming the battery pack.

In accordance with an embodiment of the present invention, a mechanical gasket may be placed between the female coolant port and the male coolant port for sealing interconnections within the battery pack.

In accordance with an embodiment of the present invention, the module terminals may close an electrical contact on stacking the at least one battery module with end plates to form the battery pack.

In accordance with an embodiment of the present invention, the battery pack may include a pack constraining frame supporting the at least one battery module. Additionally, the battery pack may include a plurality of studs which extends from a peripheral face of the pack constraining frame to engage with the at least one battery module. Furthermore, the battery pack may include an end plate which is disposed at opposite ends of the battery pack between the pack constraining frame and the battery module. Moreover, the battery pack may include a pack coolant inlet to supply the coolant fluid to the manifold of the at least one of battery module and pack coolant outlet for coolant fluid to flow out of the manifold.

It is to be understood that both the foregoing general description and the following detailed description are exemplary and explanatory only and are not restrictive of the invention, as claimed.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following figures, wherein:

FIG. 1 illustrates a perspective view of a battery pack, in accordance with an exemplary embodiment of the present invention;

FIG. 2 illustrates an exploded view of the battery pack, in accordance with an

exemplary embodiment of the present invention;

FIG. 3 illustrates a front view of the battery pack, in accordance with an exemplary embodiment of the present invention;

FIG. 4 illustrates a rear view of the battery pack, in accordance with an exemplary embodiment of the present invention;

FIG. 5 illustrates a perspective view of a battery module of the battery pack, in accordance with an exemplary embodiment of the present invention;

FIG. 6 illustrates an exploded view of the battery module of the battery pack, in accordance with an exemplary embodiment of the present invention;

FIG. 7 illustrates a front view of the battery module of the battery pack, in accordance with an exemplary embodiment of the present invention;

FIG. 8 illustrates a back view of the battery module of the battery pack, in accordance with an exemplary embodiment of the present invention;

FIG. 9 illustrates a perspective view of a second cell holder of the battery module, in accordance with an exemplary embodiment of the present invention;

FIG. 10 illustrates a front view of the second cell holder of the battery module, in accordance with an exemplary embodiment of the present invention;

FIG. 11 illustrates a cut section view of the battery module, in accordance with an exemplary embodiment of the present invention;

FIG. 12 illustrates a first half section view of the battery pack, in accordance with an exemplary embodiment of the present invention;

FIG. 13 illustrates a second half section view of the battery pack, in accordance with an exemplary embodiment of the present invention; and

FIG. 14 illustrates a process for constraining a current collector adjacent to the second cell holder of the battery module, in accordance with an exemplary embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

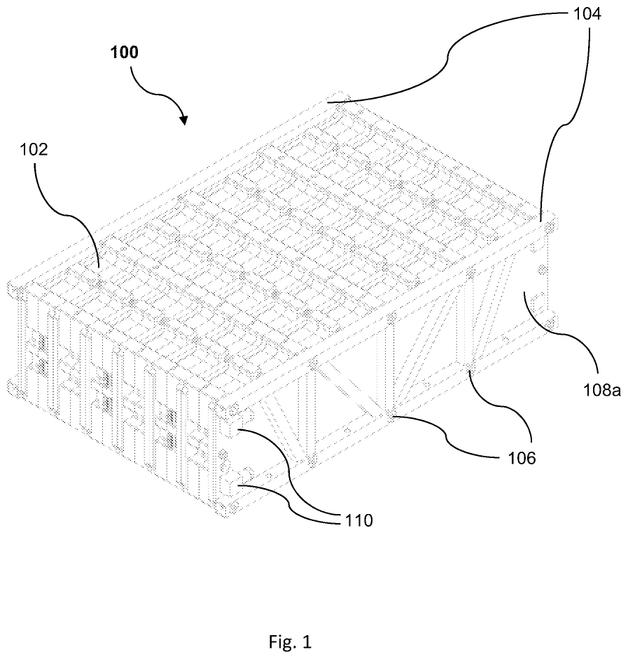

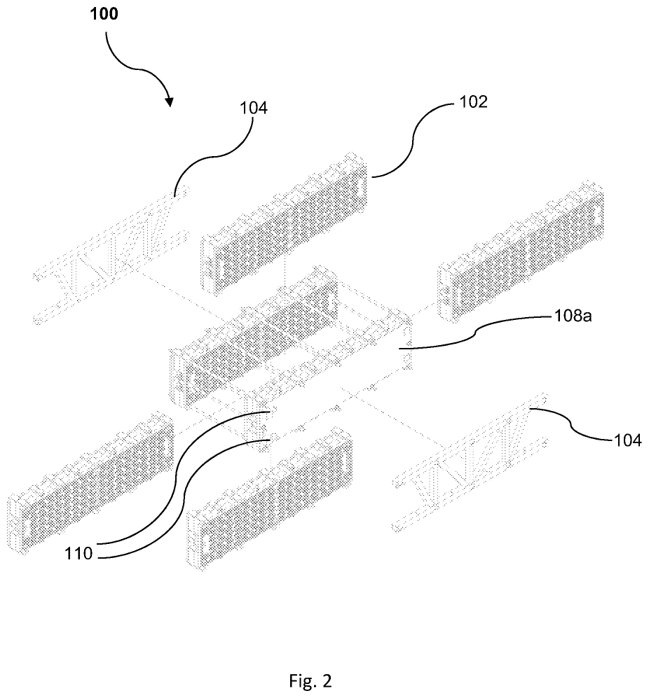

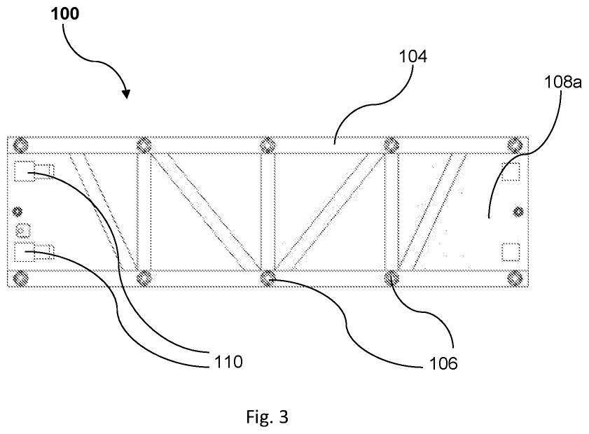

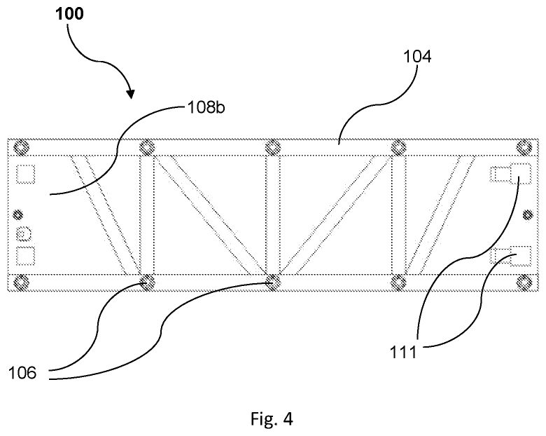

The present invention will now be described in detail with reference to the accompanying drawings. Referring now to FIG. 1, FIG. 2, FIG. 3 and FIG. 4, a perspective view, an exploded view, a front view and a rear view respectively of a battery pack (100) is illustrated, in accordance with an exemplary embodiment of the invention. The battery pack (100) may be used in various kinds of application. The application may include, but may not be limited to, electric vehicle energy storage, grid energy storage, local energy storage, and emergency energy storage.

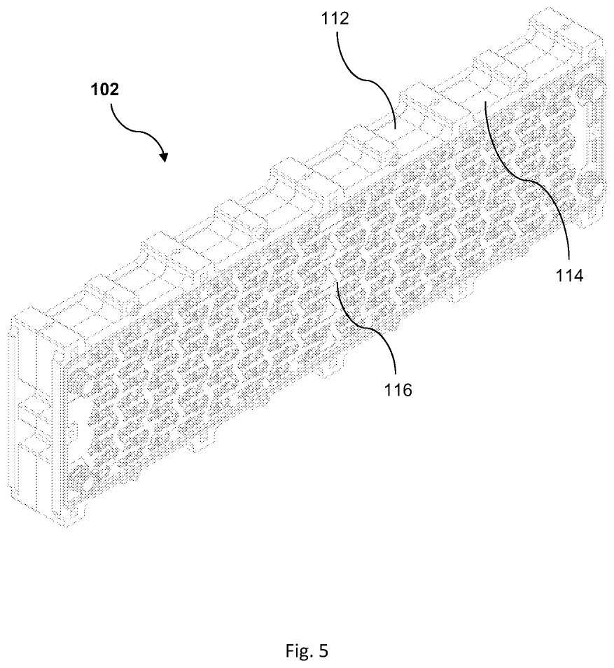

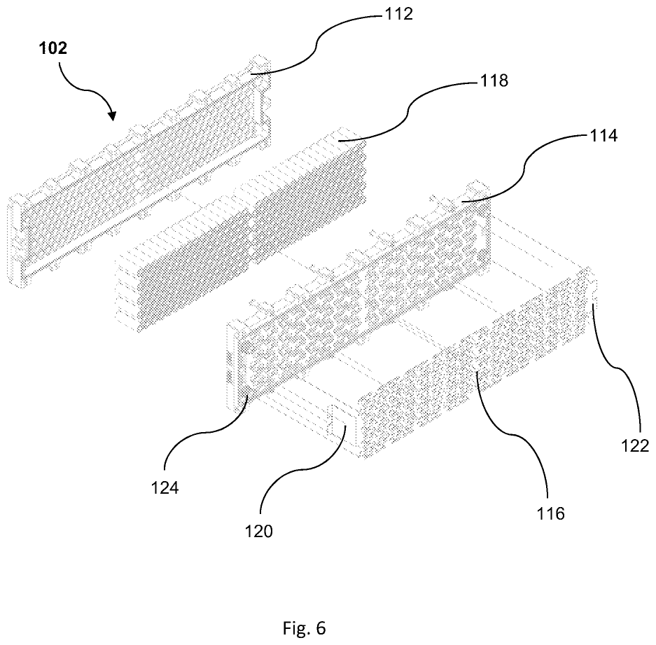

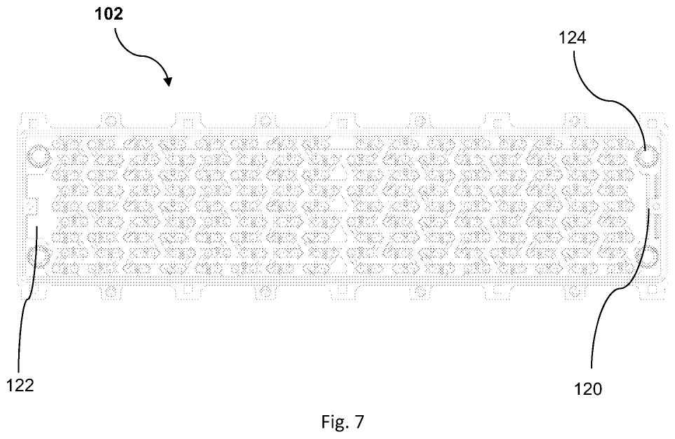

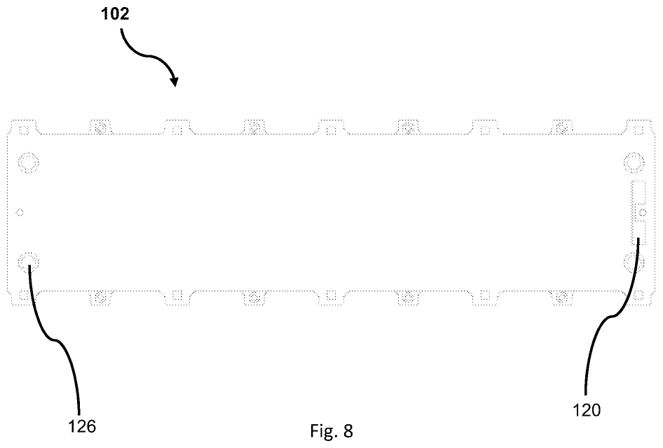

The battery pack (100) includes at least one battery module (102). Referring now to FIG. 5, FIG. 6, FIG. 7 and FIG. 8, a perspective view, an exploded view, a front view and a back view respectively of the battery module (102) is illustrated, in accordance with an exemplary embodiment of the present invention. The battery module (102) includes a plurality of cells (118). The plurality of battery cells (118) is horizontally oriented within the battery module (102) to electrically connect with the cells of adjacent battery module. The plurality of battery cells (118) may have any suitable shape including a cylindrical shape, a prismatic shape and the like. According to an embodiment, the plurality of cells (118) may be rechargeable battery cells. In such an embodiment, the plurality of cells (118) may be one of Nickel Cadmium (NiCd) cells, Nickel metal hydride (Ni-M-H) cells, or Lithium ion cells. According to another embodiment, the plurality of cells (118) may be non-rechargeable battery cells.

The battery module (102) further includes a first cell holder (112) and a second cell holder (114). In an example, the first cell holder (112) and the second cell holder (114) may be made of a material selected from a group consisting of Nylon, High Crystalline Polypropylene, and Polypropylene Copolymer. The first cell holder (112) and the second cell holder (114) each have a plurality of pockets to retain the plurality of cells (118) inside the battery module (102). The first cell holder (112) and the second cell holder (114) are operably assembled to form a manifold for partial submersion of the plurality of cells (118) within a coolant fluid and for the flow of the coolant fluid. In an example, the coolant fluid may be one of a hydrocarbon-based dielectric oil and a deionized water. In certain embodiments, the flow of the coolant fluid in the battery module (102) may be reversed at predefined intervals during high charging and discharging rates to ensure homogeneous surface temperature of the plurality of cells (118). According to an embodiment, the coolant fluid may be in contact with at least 70 percent of a curved surface area of the plurality of cells (118). Moreover, the flow of the coolant fluid may be a cross flow. Due to this, the heat transfer rate improves which subsequently ensures efficient cooling of the plurality of cells (118).

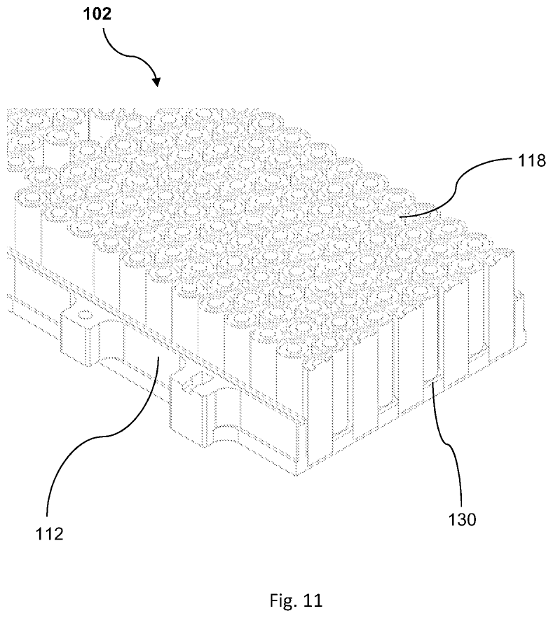

For the purpose of explanation, the first cell holder (112) and the second cell holder (114) when assembled, may resemble a case encasing the plurality of cells (118). Additionally, an interface (130) between curved surface of the plurality of cells (118) and curved surface on the plurality of pockets of at least one of the first cell holder (112) and the second cell holder (114) is sealed using a sealant. Referring now to FIG. 11, a cut section view of the battery module (102) is illustrated, in accordance with an exemplary embodiment of the invention. The battery module (102) may have the interface (130) between curved surface of the plurality of cells (118) and curved surface on the plurality of pockets of the first cell holder (112) and the second cell holder (114). Due to this, the sealant may provide structural stiffness to the battery module (102). In an example, the sealant may be any silicone-based adhesive. According to another embodiment, the interface (130) between curved surface of the plurality of cells (118) and curved surface on the plurality of pockets of at least one of the first cell holder (112) and the second cell holder (114) may be potted using epoxy resins. It will be further apparent to a person skilled in the art that the interface (130) may be sealed using any other adhesive means.

Further, an interface between the first cell holder (112) and the second cell holder (114) is sealed using at least one of a mechanical gasket and at least one projection and recess filled with the sealant. Due to this, leakage of the coolant fluid from the module (102) may be prevented and additional structural stiffness may be provided to the module (102). An example of the mechanical gasket that may be used is one of an O-ring or an elastomer-based gasket.

The first cell holder (112) and the second cell holder (114) each may have at least one coolant port to allow the flow of the coolant fluid into the battery module (102) and out of the battery module (102). According to an embodiment, the coolant port may be one of a female coolant port (126) and a male coolant port (124). In such an embodiment, the male coolant port (124) of the battery module (102) may be arranged to be received in the female coolant port (126) of the adjacent battery module (102). Additionally, the mechanical gasket may be placed between the female coolant port (126) and the male coolant port (124) to seal interconnections within the battery pack (100). Through the coolant port of the first cell holder (112) and the second cell holder (114), the flow of the coolant fluid in the battery module (102) may be reversed at the predefined intervals during the high charging and discharging rates to ensure the homogeneous surface temperature of the plurality of cells (118). In various embodiments, the coolant fluid may flow into one end of the battery module (102) and out the other end. A person skilled in art will appreciate that the flowing coolant fluid may absorb the heat generated by the plurality of cells (118).

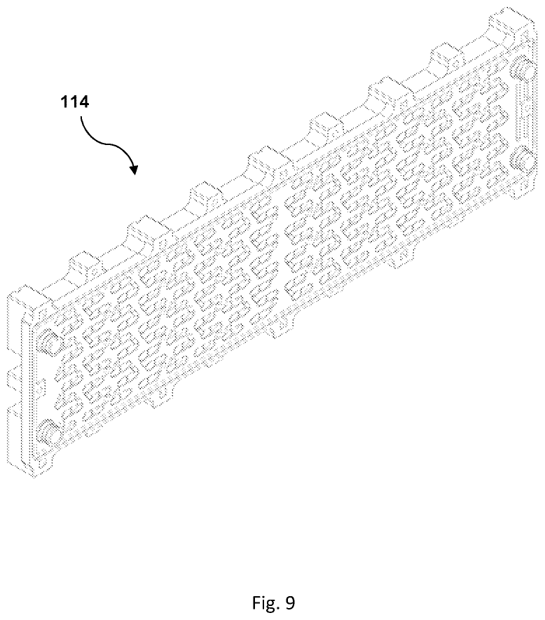

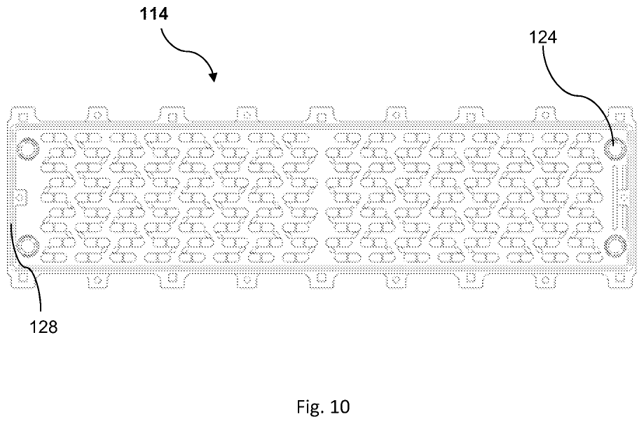

Referring now to FIG. 9 and FIG. 10, a perspective view and a front view respectively of the second cell holder (114) of the battery module (102) is illustrated, in accordance with an exemplary embodiment of the invention. According to an embodiment, the second cell holder (114) may include the male coolant port (124) and a groove (128) at one of its face. Such groove (128) may enable placement of the mechanical gasket such as O-ring. Further, the placement of the mechanical gasket in the groove (128) may enable leakage free interconnection between the battery module (102) and adjacent battery module (102) in the battery pack (100).

The battery module (102) further includes a current collector (116). The current collector (116) is electrically coupled to the plurality of cells (118). The current collector (116) includes a first module terminal (120) and a second module terminal (122). The first module terminal (120) and the second module terminal (122) of the battery module (102) are electrically connected to adjacent battery module to form the battery pack (100). Additionally, one of the first module terminal (120) and the second module terminal (122) extends throughout the length of the plurality of cells (118). According to an embodiment, the first module terminal (120) may be a positive module terminal. In such an embodiment, the positive module terminal of the current collector (116) may extend throughout the length of the plurality of cells (118) from the second cell holder (114) to the first cell holder (112). Such an arrangement may enable the first module terminal (120) and the second module terminal (122) to close an electrical contact on stacking the at least one battery module (102) to form the battery pack (100). Due to this, no separate electrical connectors may be required. Further, the first cell holder (112) and the second cell holder (114) when assembled forms the manifold for the coolant fluid to flow through, while exposing the first module terminal (120) and the second module terminal (122) on either top, or bottom, or both. The current collector (116) may enable electrical connection of the plurality of cells (118) of the battery module (102) with the cells of adjacent battery module. According to an embodiment, the cell to cell interconnection may be done through a spot welding. According to another embodiment, the cell to cell interconnection may be done through a wire bonding.

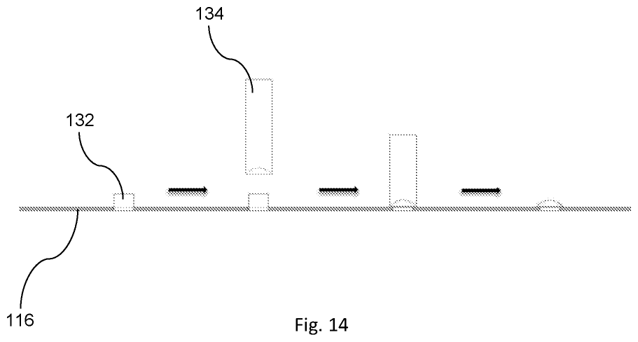

Referring now to FIG. 14, a process for constraining the current collector (116) adjacent to the second cell holder (114) of the battery module (102) is illustrated, in accordance with an exemplary embodiment of the present invention. The process corresponds to a plastic riveting process to hold the current collector (116) against the second cell holder (114). According to an embodiment, one of the first cell holder (112) and the second cell holder (114) is having a plurality of pins (132) to locate the current collector (116). The plurality of pins (132) are plastically deformed through a tool (134) to hold the current collector (116) in place adjacent to one of the first cell holder (112) and the second cell holder (114). The tool (134) applies force on the head of the plurality of pins (132) to press the plurality of pins (132) through holes of the current collector (116) and one of the first cell holder (112) and the second cell holder (114). An example of plastically deforming the plurality of pins (132) is a heating process. Another example of plastically deforming the plurality of pins (132) is an ultrasonic vibration. According to another embodiment, one of the first cell holder (112) and the second cell holder (114) may be glued to the current collector (116) using an adhesive. Hence, the first cell holder (112) and the second cell holder (114) retain the cells (118) in position, hold the current collector (116) and act as a casing of the module (102) simultaneously, thus eliminating need of additional weight.

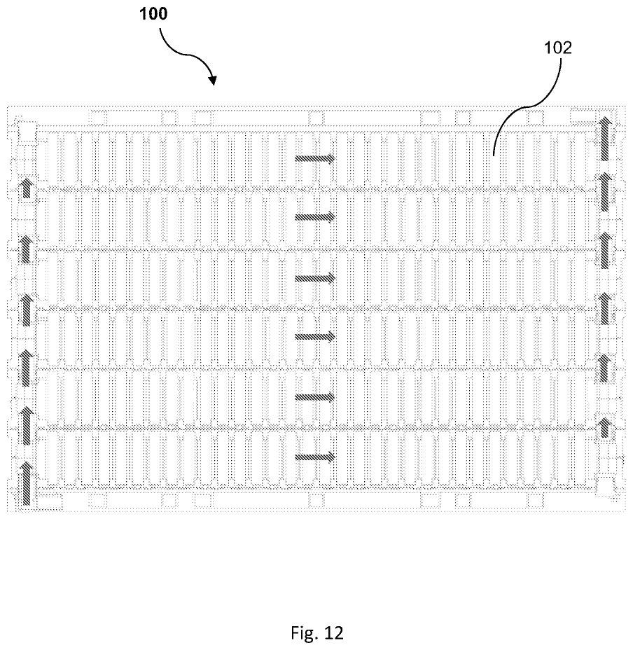

Referring now to FIG. 12, a first half section view of the battery pack (100) is illustrated, in accordance with an exemplary embodiment of the present invention. The first half section view clearly depicts the module to module interconnection within the battery pack (100) for flow of the coolant fluid and a parallel flow within the battery pack (100). The parallel flow in the battery pack (100) ensures that similar flow of the coolant fluid is maintained for each module (102). Similarly, the parallel flow in the battery pack (100) ensures that same temperature of the coolant fluid is maintained for each module (102) at inlet.

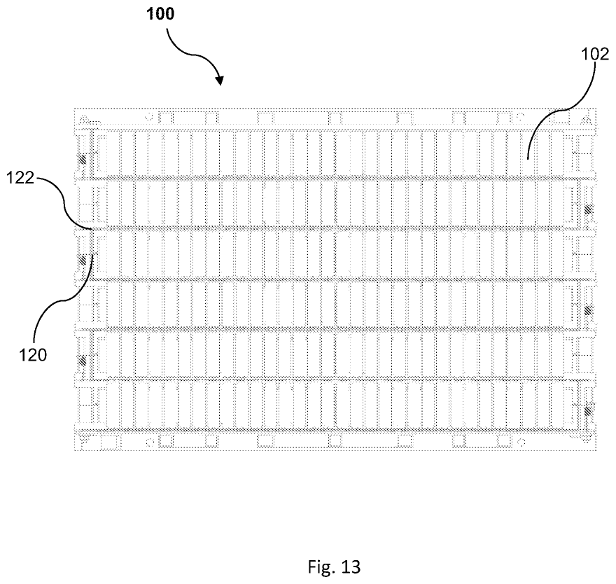

Referring now to FIG. 13, a second half section view of the battery pack (100) is illustrated, in accordance with an exemplary embodiment of the present invention. The second half section view clearly depicts that the first module terminal (120) of the battery module (102) may be pressed against the second module terminal (122) of the adjacent battery module (102) to ensure that the electrical contact is closed on stacking the at least one battery module (102) to form the battery pack (100). Further, the pressing of the first module terminal (120) and the second module terminal (122) may eliminate the need of busbars for connecting one battery module (102) to another.

Referring back to FIG. 1, FIG. 2, FIG. 3 and FIG. 4, the battery pack (100) may further include a pack constraining frame (104) supporting the at least one battery module (102). The pack constraining frame (104) may enable stacking of the least one battery module (102) to form the battery pack (100). According to an embodiment, the pack constraining frame (104) may provide structural stability to the battery pack (100) and may enable stacking of one or more elements of the battery pack (100). Further, the pack constraining frame (104) may simultaneously surround a portion of opposite sides of the battery modules (102).

The battery pack (100) may further include a plurality of studs (106). The plurality of studs (106) may extend from a peripheral face of the pack constraining frame (104) to engage with the at least one battery module (102). According to an embodiment, a plurality of holes is provided for bolting the plurality of studs (106) going through the module (102) to a battery tray.

The battery pack (100) may further include an end plate (108) disposed at opposite ends of the battery pack (100) between the pack constraining frame (104) and the battery module (102). The end plate (108a) may be secured at front end of the battery pack (100) adjacent to the pack constraining frame (104) and the battery module (102) as illustrated in FIG. 3. Similarly, the end plate (108b) may be secured at rear end of the battery pack (100) adjacent to the pack constraining frame (104) and the battery module (102) as illustrated in FIG. 4. In addition, at extreme ends of the battery pack (100), the end plates (108a and 108b) may be installed which shut the additional coolant ports and may have a provision for connection with pack positive and negative terminals. Further, the first module terminal (120) and the second module terminal (122) close the electrical contact on stacking the at least one battery module (102) with the end plates (108a and 108b) to form the battery pack (100).

The battery pack (100) may further include a pack coolant inlet (110) to supply the coolant fluid to the manifold of the at least one battery module (102). According to an embodiment, the pack coolant inlet (110) may allow flow of the coolant fluid from a coolant fluid reservoir to the manifold of the battery module (102) using a pumping device.

The battery pack (100) may further include a pack coolant outlet (111). According to an embodiment, the pack coolant outlet (111) is substantially opposite to the pack coolant inlet (110) in a diagonal direction of the battery pack (100). Additionally, the coolant fluid is allowed to discharge through the pack coolant outlet (110) after absorbing the heat generated by the plurality of cells (118) inside the battery pack (100).

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1. A battery module (102), comprising:
a plurality of cells (118);
a first cell holder (112) and a second cell holder (114) each having a plurality of pockets for retaining the plurality of cells (118) inside the battery module (102), the first cell holder (112) and the second cell holder (114) are operably assembled to form a manifold for partial submersion of the plurality of cells (118) within a coolant fluid and for the flow of the coolant fluid; and
a current collector (116) electrically coupled to the plurality of cells (118), the current collector (116) has a first module terminal (120) and a second module terminal (122),
wherein an interface (130) between curved surface of the cells (118) and curved surface on the pockets of at least one of the first cell holder (112) and the second cell holder (114) is sealed using a sealant;
wherein an interface between the first cell holder (112) and the second cell holder (114) is sealed; and
wherein one of the first module terminal (120) and the second module terminal (122) extends throughout a length of the plurality of cells (118).

2. The battery module (102) as recited in claim 1, wherein the flow of the coolant fluid in the battery module (102) is reversed at predefined intervals during high charging and discharging rates to ensure homogeneous cell surface temperature.

3. The battery module (102) as recited in claim 1, wherein the coolant fluid is one of a hydrocarbon-based dielectric oil and a deionized water.

4. The battery module (102) as recited in claim 1, wherein the coolant fluid is in contact with at least 70 percent of a curved surface area of the plurality of cells (118).

5. The battery module (102) as recited in claim 1, wherein the first cell holder (112) and the second cell holder (114) each is having at least one coolant port for allowing the flow of the coolant fluid into the battery module (102) and out of the battery module (102), the coolant port is one of a female coolant port (126) and a male coolant port (124), the male coolant port (124) of the battery module (102) being arranged to be received in the female coolant port (126) of adjacent battery module.

6. The battery module (102) as recited in claim 1, wherein the interface between the first cell holder (112) and the second cell holder (114) is sealed using at least one of a mechanical gasket and at least one projection and recess filled with the sealant.

7. The battery module (102) as recited in claim 1, wherein one of the first cell holder (112) and the second cell holder (114) is having a plurality of pins (132) to locate the current collector (116), the plurality of pins (132) are plastically deformed to hold the current collector (116) in place adjacent to one of the first cell holder (112) and the second cell holder (114).

8. The battery module (102) as recited in claim 1, wherein the first cell holder (112) and the second cell holder (114) are made of material selected from a group consisting of Nylon, High Crystalline Polypropylene, and Polypropylene Copolymer.

9. The battery module (102) as recited in claim 1, wherein the flow of the coolant fluid is a cross flow which ensures efficient cooling of the plurality of cells (118).

10. A battery pack (100), comprising:
at least one battery module (102) being stacked to form the battery pack (100), the battery module (102) comprising:
a plurality of cells (118);
a first cell holder (112) and a second cell holder (114) each having a plurality of pockets for retaining the plurality of cells (118) inside the battery module (102), the first cell holder (112) and the second cell holder (114) are operably assembled to form a manifold for partial submersion of the plurality of cells (118) within a coolant fluid and for the flow of the coolant fluid; and
a current collector (116) electrically coupled to the plurality of cells (118), the current collector (116) has a first module terminal (120) and a second module terminal (122), the first module terminal (120) and the second module terminal (122) of the battery module (102) are electrically connected to adjacent battery module to form the battery pack (100);
wherein an interface (130) between curved surface of the cells (118) and curved surface on the pockets of at least one of the first cell holder (112) and the second cell holder (114) is sealed using a sealant;
wherein an interface between the first cell holder (112) and the second cell holder (114) is sealed; and
wherein one of the first module terminal (120) and the second module terminal (122) extends throughout a length of the plurality of cells (118).

11. The battery pack (100) as recited in claim 10, wherein the flow of the coolant fluid in the at least one battery module (102) is reversed at a predefined intervals during high charging and discharging rates to ensure homogeneous cell surface temperature within the battery pack (100).

12. The battery pack (100) as recited in claim 10, wherein the coolant fluid is one of a hydrocarbon-based dielectric oil and a deionized water.

13. The battery pack (100) as recited in claim 10, wherein the coolant fluid is in contact with at least 70 percent of a curved surface area of the plurality of cells (118).

14. The battery pack (100) as recited in claim 10, wherein the first cell holder (112) and the second cell holder (114) each is having at least one coolant port for allowing the flow of the coolant fluid into the battery module (102) and out of the battery module (102), the coolant port is one of a female coolant port (126) and a male coolant port (124), the male coolant port (124) of the battery module (102) being arranged to be received in the female coolant port (126) of adjacent battery module while forming the battery pack (100).

15. The battery pack (100) as recited in claim 14, wherein a mechanical gasket is placed between the female coolant port (126) and the male coolant port (124) for sealing interconnections within the battery pack (100).

16. The battery pack (100) as recited in claim 10, wherein the interface between the first cell holder (112) and the second cell holder (114) is sealed using at least one of a mechanical gasket and at least one projection and recess filled with the sealant.

17. The battery pack (100) as recited in claim 10, wherein the module terminals (120, 122) close an electrical contact on stacking the at least one battery module (102) to form the battery pack (100).

18. The battery pack (100) as recited in claim 10, the battery pack (100) further comprising:
a pack constraining frame (104) supporting the at least one battery module (102);
a plurality of studs (106) extending from a peripheral face of the pack constraining frame (104) to engage with the at least one battery module (102);
an end plate (108) disposed at opposite ends of the battery pack (100) between the pack constraining frame (104) and the battery module (102); and
a pack coolant inlet (110) to supply the coolant fluid to the manifold of the at least one battery module (102).
